(19) United States
(12) Patent Application Publication
(10) Pub. No.: US 2012/0263824 A1
(43) Pub. Date: Oct. 18, 2012

(54) BAKING MIXES AND PROCESSES FOR MAKING THE SAME

(75) Inventor: Patrick L. Finney, Federal Way, WA (US)

(73) Assignee: Roman Meal Company

(21) Appl. No.: 13/085,907

(22) Filed: Apr. 13, 2011

(51) Int. Cl. A21D 8/04; A21D 2/00; A23L 1/302; A21D 10/00

(52) U.S. Cl. 426/20; 426/28; 426/555; 426/72

(57) ABSTRACT

The present invention is related to processes for producing baking mixes in which a whole grain is sprouted and at least a portion of the sprouted whole grain's starch content is enzymatically converted into glucose to provide a sprouted whole grain mix.

### FIELD OF THE INVENTION

The present invention is generally related to bread mixes having reduced starch content and processes for making the same.

### BACKGROUND OF THE INVENTION

Whole grains or foods made from them contain all the essential parts and naturally-occurring nutrients of the entire grain seed. If the grain has been processed (e.g., cracked, crushed, rolled, extruded, and/or cooked), the food product should deliver approximately the same rich balance of nutrients that are found in the original grain seed. However, traditional refining processes can often times remove some of the bran and germ from the grain, resulting in a loss of dietary fiber, vitamins and minerals.

The demand for the use of whole grains in the production of a variety of food products has recently increased due, at least in part, to the greater amount of nutrients therein as compared to refined baked goods such as white bread. Although the use of whole grains for the manufacture of baked goods has increased, to a majority of consumers the overall taste profile of most whole-grain products suffers, especially in the absence of additional bakery-formulated sugar and salt, or flavoring agents. The addition of such “additives” necessarily increases the cost and dilutes the nutritive value of the final baked good purchased by the consumer.

Accordingly, there remains a need for processes and baking mixes that provide an enhanced concentration of micronutrients, dietary fiber, and/or protein while also eliminating or mitigating the need for addition of sweeteners and/or flavoring agents.

### BRIEF SUMMARY OF THE INVENTION

In one aspect, the present invention provides processes for the production of baking mixes for the baking industry. Processes according to certain embodiments of the present invention include a step of sprouting a whole grain to provide a sprouted whole grain. The whole grain to be sprouted naturally includes native amounts of starch, sugar, total vitamin content, and all other native phyto-compounds. After the whole grain has been sprouted to the desired degree, a mash including particulated sprouted whole grain is prepared. The particulated sprouted whole grain can be obtained by crushing, grinding, or the like. At least a portion of the native starch can be enzymatically converted into glucose to provide a sprouted whole grain bread mix having an amount of sugar greater than the amount of native sugar in the whole grain due solely to the conversion of starch to glucose. That is, in certain embodiments the increased amount of sugar is attributed only to the conversion of the native starch to glucose. Beneficially, the resulting bakery mixes eliminate or mitigate the amount of formulated sugar added to bread and other bakery products.

In certain preferred embodiments, the present invention provides processes for the production of bakery mixes including an initial step of cleaning a whole grain to remove foreign material. After an initial cleaning, the whole grain can be soaked for 1-15 hours (e.g., 6-9 hours) in water having a temperature preferably from 20-30° C. to hydrate the whole grain. After the whole grain has been hydrated to the desired degree from soaking in water, the hydrated grain can simply be allowed to sprout from 10-40 hours (e.g., 20-30 hours) to provide a sprouted whole grain. The sprouted whole grain can be cooked in boiling water for at least 15 minutes, pressure cooked (e.g. 30 psi) for about 5-30 minutes (e.g., 10-20 minutes), or boiled and pressure cooked to gelatinize starch present in the whole grain. The cooked whole grain is then further processed in a manner to increase the surface area of the sprouted whole grain. For instance, the surface area of the sprouted whole grain can be increased by grinding, crushing, or extruding the sprouted whole grain to provide a mash. The resulting mash can be fermented for about 1-12 hours (e.g., 2-5 hours) at a temperature ranging from 20 to 60° C. (e.g., 30 to 40° C.) using a budding yeast (e.g., Saccharomyces cerevisiae). Preferably, this fermentation step utilizes Saccharomyces cerevisiaeor with 1-3% yeast solids to which enzyme-active wheat or barley malt (150-230° L) is added so that at least a portion of the gelatinized starch is converted into maltose and dextrins. Through the action of the yeast fermentation step, the pH of the mash is reduced to from 4-6 (e.g., 4.5-5.5). After the addition of the malt and yeast fermentation of the mash, an initial hydrolysis of the mash is performed to hydrolyze starch, primarily, into dextrins and maltose. In certain embodiments, the temperature of the fermented mash is increased to about 45 to 65° C. for 10 to 50 minutes (e.g., 25-35 minutes) to malt-hydrolyze the mash followed by increasing the temperature to about 70 to 80° C. for 10 to 50 minutes (e.g., 25-35 minutes). A subsequent fermentation can be performed to further hydrolyze the dextrins and maltose into glucose. In certain embodiments, for instance, fungal glucoamylase can be added to the fermented and enzyme-hydrolyzed mash to further hydrolyze the dextrins and maltose into glucose. The hydrolysis of the dextrins and maltose into glucose can be carried out at a temperature from about 50 to 70° C. for about 30 minutes to about 4 hours according to certain embodiments of the present invention. After the desired degree of conversion to glucose has been obtained, the mash temperature is preferably increased (e.g., increased to at least 90° C. for about 15 minutes or more) such that certain constituents in the mash are heat-denatured (e.g., to inactivate all enzymes) to provide a sprouted whole grain bread mix having an amount of sugar greater than the amount of native sugar in the whole grain due solely to the conversion of the native starch to glucose.

In another aspect, the present invention provides bakery mixes (e.g., wet and-dry-bread mixes). Bread mixes according to embodiments of the present invention can include sprouted whole grain particulates, in which the bread mix has a starch content of less than 50% by weight calculated on a dry basis and a glucose content ranging from 10-75% by weight calculated on a dry basis in the absence of the addition of formulated sugar. That is, the glucose content of the final mix is due entirely to the conversion of native starch into glucose, not the addition of non-native sugar or sugar derived from non-native starch or saccharides.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a flow diagram illustrating processing steps according to one embodiment of the present invention; and

FIG. 2 is a flow diagram illustrating processing steps according to certain preferred embodiments of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

As used herein, the term “whole grain(s)” can include cereal grains that consist of the intact and unrefined, ground, cracked or flaked fruit of the grains whose principal components—the starchy endosperm, germ and bran—are present in the same relative proportions as they exist in the intact grain. In certain embodiments, the term “whole grain” can include intact and unrefined starch-containing edible seeds including cereal grains such as barley, corn, millet, rice, rye, oats, sorghum, spelt, triticale, wheat, and other edible seeds including buckwheat, wild rice, quinoa, amaranth, teff, and combinations thereof.

In one aspect, the present invention provides processes designed to create wet- and dry-mixes from sprouted whole grains. In certain embodiments of the present invention, the processes can transform inherent grain micronutrients (including vitamins, minerals, antioxidants, etc), dietary fiber, and protein, and convert a desired amount of starch to a desired amount of glucose to provide mixes have decreased starch content and an increased glucose content as compared to traditional processes utilized for making bread mixes. Accordingly, embodiments of the present invention eliminate or at least mitigate the amount of formulated sugar that is traditionally added to baking mixes in bakeries to provide a desirably tasting baked good. In other words, the conversion of at least a percentage of a whole grain's native starch into glucose can effectively replace or mitigate the addition of formulated sugar in bread and other bakery products.

Beneficially, resulting bakery mixes produced from processes according to certain embodiments of the present invention eliminate or mitigate the amount of formulated sugar added to bread and other bakery products. Moreover, an equally “sweet” tasting bread product can be provided without the addition of formulated sugar, while also providing an increased concentration of micronutrients.

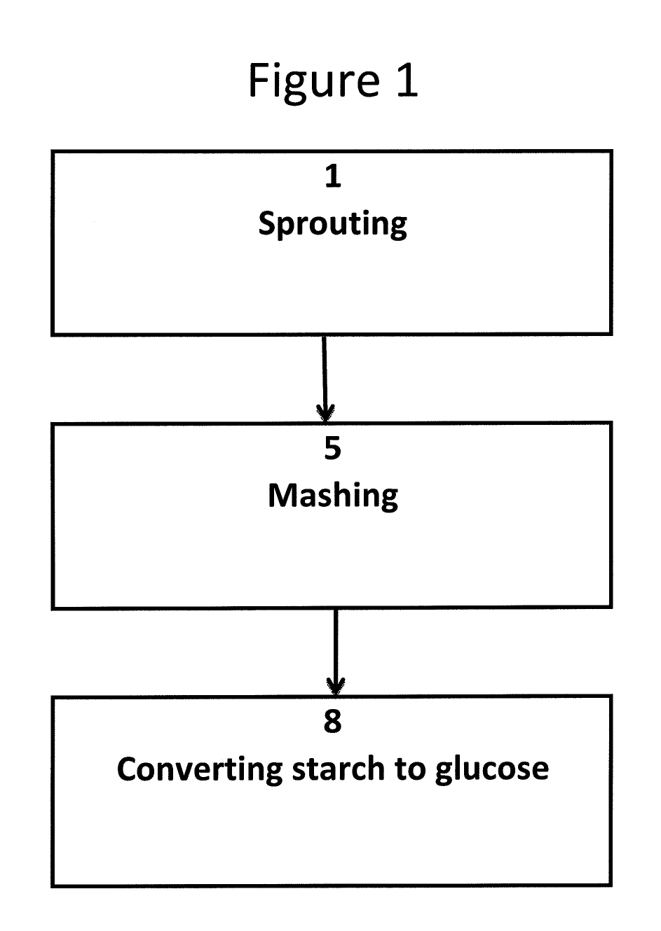

As shown in FIG. 1, processes according to certain embodiments of the present invention include a sprouting step 1 in which a whole grain is allowed to germinate to provide a sprouted whole grain. The whole grain to be sprouted naturally includes native amounts of starch, sugar, total vitamin content, and all other native phyto-compounds. After the whole grain has been sprouted to the desired degree, a mash generation step 5 is performed in which the sprouted whole grain is milled, crushed, or extruded (with or without water and/or heat) to increase the surface area of the sprouted whole grain to provide particulated sprouted whole grain. The particulated sprouted whole grain can be added to water (or vice versa) to provide a mash including the particulated sprouted whole grain. After generation of the mash, at least a portion of the whole grain's native starch can be enzymatically converted 8 into glucose to provide a sprouted whole grain bake mix. Resulting sprouted whole grain bake mixes have an amount of glucose greater than the amount of native glucose in the whole grain due solely to the conversion of the whole grain's native starch to glucose. That is, in certain embodiments the increased amount of glucose is attributed only to the conversion of the whole grain's native starch to glucose.

In certain embodiments, the whole grain is preferably initially cleaned by removing non-grain material by using air aspiration and/or water washing, for example, followed by soaking the cleaned whole grain prior to the sprouting step to hydrate the whole grain. Preferably the whole grain is soaked in excess water having a temperature from 20-40° C. (e.g., 20-30° C.) for several hours (e.g., 1-20 hrs, 3-10 hrs, or 6-9 hrs). After the whole grain has been soaked in water for the desired time (e.g., desired level of hydration is obtained), the whole grain can be removed or separated from the water and allowed to germinate for about 12 to about 40 hours depending on a user's desired degree of germination. In certain embodiments, the sprouting step comprises allowing the whole grain to sprout from 12 to 30 hours, from 15 to 25 hours, or from 20 to 25 hours. The sprouting step beneficially enhances the nutritional profile and enhances nutrient bioavailability.

The sprouted whole grain, according to certain embodiments of the present invention, can be cooked at an elevated temperature in water in order to further hydrate the sprouted whole grain and to gelatinize the whole grain's starch. For instance, the sprouted whole grain can be cooked in water at a temperature from 30 to 100° C. (e.g., 50-100, 70-100, 90-100, or 90-99° C.). The cooking time can vary depending on the desired degree of gelatinization of the whole grain's starch and the temperature at which cooking is carried out. For example, cooking times can vary from 5-60 minutes (e.g., 5-45 minutes, 5-30 minutes, or 10-20 minutes). In certain preferred embodiments, the sprouted whole grain is cooked for about 10-15 minutes in near boiling (e.g. 97-99° C.) or boiling water (100° C.).

Alternatively, the sprouted whole grain can be pressure cooked (e.g. 10-30 psi, 15-25 psi above atmospheric conditions) for 5-60 minutes (e.g., 5-45 minutes, 5-30 minutes, 10-30 minutes, or 8-10 minutes) at an elevated temperature (e.g., 115-142° C.) to gelatinize the sprouted whole grain's starch. According to certain embodiments, the sprouted whole grain can be pressure cooked in elevated temperatures as previously described.

In certain preferred embodiments, the sprouted whole grain (either before or after cooking) can be physically manipulated to form particulates thereof. The sprouted whole grain can be milled, crushed, or extruded such that the surface area of the sprouted whole grain is increased. The physically manipulated sprouted whole grain typically provides particulated sprouted whole grain that can be added to water (or vice versa) to provide a mash including the particulated sprouted whole grain. The resulting mash can be subjected to a fermenting step and the addition of an enzyme-active malt to convert more than 50% (e.g., 50-100%, 70-99%, 75-95%) of the gelatinized starch (due to the cooking operation) into maltose and dextrins and to lower the mash pH to a desirable level (e.g., between 4.5 and 5.5). A percentage (e.g., 1-100%, 50-100%, 80-100%, 90-100%) of the maltose and dextrins can be enzymatically hydrolyzed further into glucose.

According to certain embodiments of the present invention, the resulting sprouted whole grain mixes can have a starch content from 1-10% (e.g., 1-8%, 2-6%, 3-5%) by weight calculated on a dry basis. Moreover, the resulting mixes can include a glucose content of from 10-90% (e.g., 25-85%, 45%-80%, 55-70%, or 60-70%) by weight calculated on a dry basis in the absence of the addition of formulated sugar or other formulating additives. Additionally, the resulting mixes can have a total vitamin content ranging from 10-75% (e.g., 10-60%, 30-60% or 40-60%) larger than the native total vitamin content of the starting whole grain. As such, resulting mixes produced according to certain embodiments of the present invention provide an enhanced concentration of micronutrients, dietary fiber, and protein while also eliminating or mitigating the need for addition of sweeteners and/or flavoring agents.

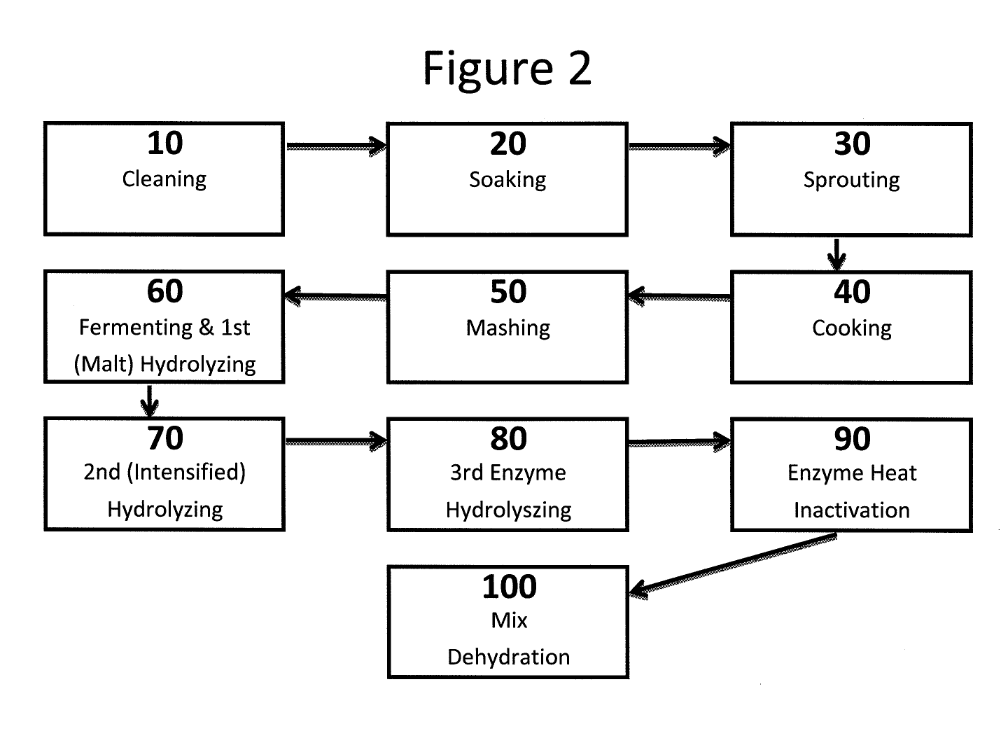

In certain preferred embodiments, processes for the production of baking mixes (e.g., bread mixes) include a particular sequence of processing steps as illustrated in FIG. 2. As shown in FIG. 2, particularly preferred embodiments according to the present invention include an initial cleaning step 10 in which the foreign material is removed from the whole grain. The whole grain to be sprouted naturally includes native amounts of starch, sugar, total vitamin content, and all other native phyto (plant)-compounds. For instance, viable and disease-free whole grain (e.g., wheat or other high-starch-containing grain and other edible seeds) can be thoroughly cleaned to remove foreign, non-grain material by air aspirating, sifting, and washing and rinsing with water.

After the whole grain has been cleaned to the desired extent, the whole grain can be subjected to a water soaking step 20. In the soaking step 20, the whole grain can be soaked for 1-15 hours (e.g., 3-12 hours or 6-9 hours) in excess water having a temperature from 15-40° C. (e.g., 20-40° C., or 20-30° C.) to facilitate hydration of the whole grain. After soaking in excess water, the whole grain (which has been hydrated to the desired degree) is separated from the water and undergoes a sprouting step 30 in which the whole grain is allowed to germinate/sprout for 10-40 hours (e.g., 15-30 hours, 20-30 hours). Soaking and germinating the whole grain beneficially hydrates the grain, enhances grain nutrient profile, enhances grain nutrient bioavailability, generates enzymes, and begins hydrolysis of the whole grain's starch.

In certain embodiments, the soaking water is changed once or twice during the soaking period. Harder, more dense whole grains (e.g., hard spring or winter wheat) can be soaked for a longer period of time than softer-textured grain that hydrates more quickly. After proper hydration, the whole grain is drained and allowed to germinate, or sprout, for 21-24 hr. If greater transformation of the grain is desired, germination time can be extended. Germination enhances the grain nutrient profile as it increases most vitamins, increases many essential amino acids, and increases bioavailability of many micro- and macro-nutrients.

According to embodiments illustrated in FIG. 2, the whole grain undergoes a cooking step 40 after sprouting. For example, the sprouted whole grain can be cooked in boiling water for at least 15 minutes, pressure cooked (e.g. 10-30 psi above atmospheric conditions) for about 5-30 minutes (e.g., 10-20 minutes), or boiled and pressure cooked to gelatinize starch present in the whole grain. That is, after germinating the whole grain, it is cooked preferably in boiling water at least 15 or 30 minutes or pressure cooked (e.g., 15 psi) for at least 15 minutes in order to gelatinize starch and, if desired, to further hydrate grain. Gelatinizing the starch prepares the starch for hydrolysis by wheat or barley malt alpha- and beta-amylases into maltose and various chain-length dextrins, which in turn can be hydrolyzed into glucose.

After the cooking step 40, the cooked whole grain can be physically manipulated in a manner to form a mash 50 (with or without water and/or heat) including particulated sprouted whole grain. That is, the cooked whole grain is then further processed in a manner to increase the surface area of the sprouted whole grain. The surface area of the sprouted whole grain can be increased by grinding, crushing, or extruding the sprouted whole grain to provide a particulates of sprouted whole grain to which water can be added (or vice versa) to generate a mash. For instance, the whole grain can be mashed or coarsely ground in order to free various grain components and to increase component surface area, particularly gelatinized starch, in preparation for yeast fermentation and malt-hydrolysis into maltose and dextrins. In certain embodiments, the heating and mashing steps can be combined in modern heating-and extruding devises. The intensity of the grinding will typically depend on the particle size distribution of the fiber-rich bran that is desired for final products.

The mash generated in step 50 is subjected to a yeast fermentation step 60 in which the mash is fermented for 1 to 10 hours (e.g., 2-7 hours, or 2-5 hours) at a temperature ranging from 25 to 50° C. (e.g., 30-50, 30-40, or 35-40° C.) using, preferably, ordinary baker's yeast—Saccharomyces cerevisiae—with 1-3% yeast solids to which enzyme-active wheat or barley malt (150-230° L) is added in order to convert majority or most of the gelatinized starch into maltose and dextrins and to lower the mash pH to between 4-6 (e.g., 4.5-5.5). Preferably, most of the gelatinized starch can be converted into maltose and dextrins and the mash pH is lowered to between 4.5 and 5.5 in order to maximize future conversion to glucose. More or less yeast and more or less-active malt can be formulated but if so, both time and temperature must be appropriately re-balanced.

After the fermentation step 60, the mash is subjected to a second, or “intensified” hydrolysis step 70 in which the temperature of the fermented mash is increased to 45-65° C. (e.g., 45 to 65° C., 55 to 65° C.) for 15-60 minutes (e.g., 20-40, 25-35 minutes) to malt hydrolyze the mash followed by increasing the temperature to about 70-90° C. (e.g., 70-80° C., or 70-75° C.). The fermentation and first hydrolysis steps 60, 70 hydrolyze starch into (primarily) dextrins and maltose. By this point in the process, virtually all of the whole grain's starch has been sufficiently cleaved into dextrins.

In certain embodiments, after much of the starch has been hydrolyzed into maltose and dextrins and the pH lowered to about 5.0, the fermented mash is heated to between 45-60° C. (depending on the malt used) for 1-3 hr in order to enhance the degree of starch conversion to maltose and shorter-chain-length dextrins. The high degree of starch conversion is typically sought so that a subsequent hydrolysis step utilizing glucoamylase will most effectively convert maltose and dextrins to glucose.

Following fermentation and the initial- and intensified- hydrolyses, a second hydrolysis step 80 is performed for 1-4 hours (e.g., 1-3 hours) to convert the maltose and dextrins into glucose via addition of fungal glucoamylase to the fermented and enzyme-hydrolyzed mash. For instance, after most of the gelatinized starch has been converted to maltose and comparatively short-chain dextrins, fungal glucoamylase can be added to the fermented and enzyme-hydrolyzed mash and held for 1-3 hours at 45-65° C. in order to convert the maltose and dextrins to glucose. The time and temperature of incubation depends on the source of the glucoamylase and on the enzyme activity optima. By definition, one glucoamylase unit (GAU) is the amount of enzyme activity that will liberate one (1) gram of reducing sugar as D-glucose per hour under the optimum conditions recommended by the glucoamylase provider. If, for instance, the formulated glucoamylase has an activity of 440GAU/ml, an optimum incubation temperature of 62° C., and the substrate contains 1 Kg of hydrolyzed starch, 1.0 ml of glucoamylase would require an incubation period of 2.5-3.0 hr (60°-65° C.) in order to convert nearly all of the maltose and short-chain dextrins into D-glucose. In all cases the amount of glucoamylase to be formulated will depend on its activity (GAU/ml), on the amount of substrate, and on the desired termination time.

As shown in FIG. 2, the mash undergoes an enzyme heat-inactivation step 90 after hydrolysis to D-glucose is to the desired point. For instance, the mash temperature is increased such that certain constituents in the mash are heat-denatured after a desired percentage of the maltose and dextrins have been converted to glucose to provide a sprouted whole grain bread mix having an amount of sugar greater than the amount of native sugar in the whole grain due solely to the conversion of starch to glucose. In certain embodiments, the mash temperature is raised above 90, preferably 95-100° C., for about 15-20 minutes in order to heat-denature, and therefore inactivate both added and inherent grain enzymes. Heat inactivation of the mash is particularly desirable if the mash is designed to be formulated in food products, such as yeast fermented breads that involve extended bake times in which the dough or batter temperature is comparatively slowly elevated through the optimum activity temperature of the inherent or added amylases, glucoamylase, or other enzymes. If the enzymes in the mash were not totally inactivated, the end-product quality of breads and other similarly baked products would likely possess an undesirable “gummy” crumb grain from the non-heat-denatured enzymes.

According to certain embodiments of the present invention, the resulting sprouted whole grain mixes can have a starch content from 1-10% (e.g., 1-8%, 2-6%, 3-5%) by weight calculated on a dry basis. Moreover, the resulting mixes can include a glucose content of from 10-90% (e.g., 25-85%, 45%-80%, 55-70%, or 60-70%) by weight calculated on a dry basis in the absence of the addition of formulated sugar or other formulating additives. Additionally, the resulting mixes can have a total vitamin content ranging from 10-75% (e.g., 10-60%, 25-60%, or 40-60%) larger than the native total vitamin content of the starting whole grain. As such, resulting mixes produced according to certain embodiments of the present invention provide an enhanced concentration of micronutrients, dietary fiber, and protein while also eliminating or mitigating the need for addition of sweeteners and/or flavoring agents.

As shown in FIG. 2, processes according to embodiments of the present invention can include a mash dehydration step 100. A mash dehydration step 100 can be particularly important when producing a “dry mix” preparation. According to certain embodiments, the moisture content of the mash prior to dehydration can vary from about 30-80% (e.g., 45-65%), depending on the amount of water that imbibed during the soaking and/or cooking steps or is otherwise added during the process. In certain embodiments, water addition is limited so as to not exceed a ratio of about 55:45 (e.g., 20-55:45-80, 40-55:45-60, 50-60:40-50) water to solids, in the final product before dehydration. By limiting the amount of water added, the cost of dehydrating the mash can be minimized. According to certain embodiments, a user can select a target moisture content of the final product/mix (e.g., the dehydrated mash). The target moisture content of a mix (the dehydrated mash) will be a function of the water activity of the mash (mix). As dehydration of the mash progresses, the percent solids increases as does the percent sugar (D-glucose).

In certain embodiments, a “wet mix” preparation is provided. As discussed above, the water addition during the processing steps is limited so as to not exceed a ratio of about 55:45, water to solids. For example, an enzyme heat-inactivated mash can contain ˜60% water and ˜40% solids prior to any dehydration, and contain ˜24% and ˜25% sugar, respectively. For certain “wet mix” preparations, cooked mashes can simply be packaged at this point without removing any water. However, even though the mash will have been cooked (e.g., for at least 15 minutes at 98° C.-100° C.), after packaging the individual packages (with contents) should be retorted in order to insure their sterile condition will remain indefinitely. For financial reasons related primarily to the cost of shipping, however, in certain embodiments the mash is dehydrated to about 40% moisture (60% solids) in order to reduce shipping costs to a minimum. Because of the water activity and the relative amount of sugars in the solids, the cost of dehydrating the first 10-15% of the water in the mash is comparatively inexpensive, compared to the cost of dehydrating thereafter. That is, dehydrating water from relatively high sugar concentrations becomes increasingly more and more difficult.

In another aspect, the present invention provides bakery mixes (e.g., wet and-dry-bread mixes). Baking mixes according to embodiments of the present invention can include sprouted whole grain particulates, in which the bread mix has a starch content of less than 50% by weight calculated on a dry basis and a glucose content ranging from 10-75% by weight calculated on a dry basis in the absence of the addition of formulated sugar. That is, the glucose content of the final mix is due entirely to the conversion of native starch into glucose, not the addition of non-native sugar or sugar derived from non-native starch or saccharides.

In certain embodiments, the starch content of the mix ranges from 1-20% (e.g. 1-10%, 1-8%, 2-6%, 1-5% or 3-5%) by weight calculated on a dry basis. Moreover, the resulting mixes can include a glucose content of from 10-90% (e.g., 25-85%, 45%-80%, 55-70%, or 60-70%) by weight calculated on a dry basis in the absence of the addition of formulated sugar or other formulating additives. Additionally, the resulting mixes can have a total vitamin content ranging from 10-75% (e.g., 10-60%, 30-60% or 40-60%) larger than the native total vitamin content of the starting whole grain in the absence of formulated vitamin addition. As such, resulting mixes produced according to certain embodiments of the present invention provide an enhanced concentration of micronutrients, dietary fiber, and protein while also eliminating or mitigating the need for addition of sweeteners and/or flavoring agents.

Baking mixes according to certain preferred embodiments include a starch content ranging from 1-10% by weight calculated on a dry basis, a glucose content ranging from 55-70% by weight calculated on a dry basis in the absence of the addition of formulated sugar, and a total vitamin content which is from 15-60 percent larger than a vitamin content of the unsprouted whole grain used for producing the mixes in the absence of formulated vitamin addition.

### EXAMPLES

As illustrated in Table 1, both the hard- and the soft-wheat mashes produced according to one embodiment of the present invention contained 60% water and 40% solids prior to dehydration, and contained 24.05% and 25.42% sugar, respectively. Mashes were dehydrated to 80% solids and 20% water. At 20 percent moisture, the percentage of sugars was 50.83% and 48.09%, respectively, for the soft- and hard-wheat mashes.

TABLE 1
Effects of Process Steps on Nutrient Composition

| | | | Soft Red Wheat¹ | | | | Hard White Wheat¹ | | | |
|---|---|---|---|---|---|---|---|---|---|---|
| | | Whole | | Cooked | Finished | | | Cooked | Finished | |
| g/100 g | | Wheat | As | Sprouts | Mash | Dehydrated | As | Sprouts | Mash | Dehydrated |
| Component | | Range | Rec'd | Wet | Wet | Mash | Rec'd | Wet | Wet | Mash |
| Protein | g | 8-16 | 10.20 | 5.46 | 4.74 | 9.49 | 13.60 | 7.27 | 6.33 | 12.65 |
| Starch | g | 55-61 | 59.76 | 31.96 | 2.78 | 5.56 | 56.66 | 30.31 | 2.64 | 5.27 |
| Sol. Fiber | g | 1-1.5 | 1.30 | 0.70 | 0.60 | 1.21 | 1.10 | 0.59 | 0.51 | 1.02 |
| InSol. Fiber | g | 10.4-11.1 | 10.80 | 5.78 | 5.02 | 10.05 | 10.70 | 5.72 | 4.98 | 9.95 |
| Sugar | g | 0.65-0.80 | 0.75 | 0.40 | 25.42 | 50.83² | 0.70 | 0.37 | 24.05 | 48.09² |
| Oil | g | 1.4-1.65 | 1.50 | 0.80 | 0.70 | 1.40 | 1.60 | 0.86 | 0.74 | 1.49 |
| Ash | g | 1.45-1.90 | 1.65 | 0.88 | 0.77 | 1.53 | 1.60 | 0.86 | 0.74 | 1.49 |
| Vitamins⁴ | mg | 5-7 | 6.60 | 5.30 | 4.61 | 9.22 | 6.20 | 4.97 | 4.33 | 8.65 |
| All Other³ | mg | 27-37 | 32.05 | 17.40 | 15.12 | 30.23 | 32.90 | 17.60 | 15.30 | 30.60 |
| Water | g | 9-15 | 14 | 54 | 60 | 20 | 14 | 54 | 60 | 20 |
| Total | g | 100 | | | | | | | | |
| Dry Weight | g | 91-85 | 86 | 46 | 40 | 80 | 86 | 46 | 40 | 80 |

¹Calculated based on ratio wet:dry weight
²Estimated 90% conversion of starch to D-glucose.
³Calculated by 100 minus sum of all other Component.
⁴Average sum of total vitamins increased 50% due to sprouting

Many modifications and other embodiments of the invention set forth herein will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for the production of bread mixes, comprising:
(a) sprouting a whole grain to provide a sprouted whole grain, wherein said whole grain includes a native amount of starch, sugar, and total vitamin content therein;
(b) generating a mash including particulated sprouted whole grain;
(c) enzymatically converting at least a portion of the starch into glucose to provide a sprouted whole grain bread mix having an amount of sugar greater than the amount of native sugar in the whole grain due solely to the conversion of starch to glucose.

2. The process of claim 1, wherein the whole grain is cleaned by removing non-grain material followed by soaking in water to hydrate the whole grain prior to the sprouting step.

3. The process of claim 1, wherein sprouting step comprises allowing the whole grain to sprout from 12 to 40 hours.

4. The process of claim 1, wherein the sprouted whole grain is cooked at an elevated temperature in water in order to gelatinize the sprouted whole grain starch and, if desired, to further hydrate the sprouted whole grain.

5. The process of claim 1, wherein the sprouted whole grain is pressure cooked at an elevated temperature from 10 to 30 minutes in order to further hydrate the sprouted whole grain and to gelatinize starch.

6. The process of claim 1, wherein the sprouted whole grain is cooked followed by physically manipulating the sprouted whole grain to form particulates thereof to provide a mash.

7. The process of claim 4, wherein the enzymatically converting step comprises (i) fermenting the mash and adding an enzyme-active malt to convert more than 50% of the gelatinized starch into maltose and dextrins and to lower the mash pH to between 4.5 and 5.5; and (ii) enzymatically hydrolyzing maltose and dextrins to glucose.

8. The process of claim 1, wherein the resulting sprouted whole grain bread mix comprises: (a) a starch content from 1-10% by weight calculated on a dry basis; (b) a glucose content from 55-70% by weight calculated on a dry basis in the absence of the addition of formulated sugar; and (c) a total vitamin content comprising from 15-60% larger than the native total vitamin content of the starting whole grain due to the sprouting step.

9. A process for the production of bread mixes, comprising:
(a) cleaning a whole grain to remove foreign material, wherein said whole grain includes a native amount of starch, sugar, and total vitamin content therein;
(b) soaking the whole grain for 6-9 hours in water having a temperature from 20-30° C. to hydrate the whole grain;
(c) separating the hydrated grain from the water in step (b) after the whole grain has been hydrated to the desired degree and allowing the whole grain to sprout for 20-30 hours to provide a sprouted whole grain;
(d) cooking the sprouted whole grain in boiling water for at least 15 minutes to gelatinize starch present in the whole grain, or pressure cooking at a pressure from about 15-30 psi above environment conditions, or a combination thereof;
(e) increasing the surface area of the sprouted whole grain by grinding the sprouted whole grain to provide a mash;
(f) fermenting the mash for 2-5 hours at a temperature ranging from 30 to 40° C. using Saccharomyces cerevisiae or the like with 1-3% yeast solids to which enzyme-active wheat or barley malt (150-230° L) is added so that at least a portion of the gelatinized starch is converted into maltose and dextrins; wherein the pH is reduced to about 4.5 to 5.5 through the action of the yeast fermentation;
(g) increasing the temperature of the fermented mash from step (f) to 45 to 65° C. and converting the maltose and dextrins from step (f) into glucose via addition of fungal glucoamylase to the fermented and enzyme-hydrolyzed mash and holding for 1-4 hours;
(h) increasing the mash temperature such that the mash is heat-denatured after a desired percentage of the maltose and dextrins have been converted to glucose to provide a sprouted whole grain bread mix having an amount of sugar greater than the amount of native sugar in the whole grain due solely to the conversion of starch to glucose.

10. The process of claim 9, wherein the resulting sprouted whole grain bread mix comprises: (a) a starch content from 1-10% by weight calculated on a dry basis; (b) a glucose content from 55-70% by weight calculated on a dry basis in the absence of the addition of formulated sugar; and (c) a total vitamin content comprising from 15-60% larger than the native total vitamin content of the starting whole grain due solely to the sprouting step.

11. A bread mix, comprising: sprouted whole grain particulates; wherein the bread mix comprises a starch content of less than 50% by weight calculated on a dry basis and a glucose content ranging from 10-75% by weight calculated on a dry basis in the absence of the addition of formulated sugar.

12. The bread mix of claim 11, wherein the starch content ranges from 1-20% by weight calculated on a dry basis.

13. The bread mix of claim 11, wherein the starch content ranges from 1-10% by weight calculated on a dry basis.

14. The bread mix of claim 11, wherein the glucose content ranges from 40-70% by weight calculated on a dry basis in the absence of the addition of formulated sugar.

15. The bread mix of claim 11, wherein the glucose content ranges from 55-70% by weight calculated on a dry basis in the absence of the addition of formulated sugar.

16. The bread mix of claim 11, wherein the sprouted whole grain particulates comprise ground particulates of sprouted cereal grains or other edible seeds.

17. The bread mix of claim 16, wherein sprouted whole grain particulates comprise ground particulates of corn, rice, barley, rye, spelt, triticale, buckwheat, wild rice, quinoa, amaranth, teff, or combinations thereof.

18. The bread mix of claim 11, wherein the bread mix further comprises a total vitamin content which is from 10-60 percent larger than a vitamin content of the unsprouted whole grain used for producing the bread mix in the absence of formulated vitamin addition.

19. The bread mix of claim 11, wherein (a) the starch content ranges from 1-10% by weight calculated on a dry basis; (b) the glucose content ranges from 55-70% by weight calculated on a dry basis in the absence of the addition of formulated sugar; and (c) a total vitamin content which is from 10-60 percent larger than a vitamin content of the unsprouted whole grain used for producing the bread mix in the absence of formulated vitamin addition.
